(19) United States
(12) Patent Application Publication
(10) Pub. No.: US 2017/0248624 A1
(43) Pub. Date: Aug. 31, 2017

(54) SAMPLE CONTAINER CARRIER

(71) Applicant: Roche Diagnostics Operations, Inc., Indianapolis, IN (US)

(72) Inventors: Marcel Kaeppeli, Merenschwand (CH); Pius Hermann, Urswil (CH)

(21) Appl. No.: 15/434,660

(22) Filed: Feb. 16, 2017

(30) Foreign Application Priority Data
Feb. 25, 2016 (EP) 16157465.2

(51) Int. Cl. G01N 35/04; B01L 9/06

(52) U.S. Cl. CPC G01N 35/04; B01L 9/06; G01N 2035/0401; B01L 2200/025

(57) ABSTRACT

A sample container carrier for transporting sample containers, for example test tubes and/or vials, in a laboratory automation system is presented. The sample container carrier comprises a body having a hollow center with a central axis (A). The hollow center is adapted for receiving a lower end of a sample container. The sample container carrier also comprises at least three resiliently deformable and/or displaceable upper retaining elements. The upper retaining elements are distributed about the central axis (A) and adapted to clamp a sample container inserted in the hollow center of the body. The upper retaining elements are made of plastic. A method for manufacturing a sample container carrier is also presented. At least the upper retaining elements are formed by injection molding. A laboratory sample distribution system having a number of sample container carriers and a laboratory automation system comprising a laboratory sample distribution system are also presented.

### CROSS-REFERENCE TO RELATED APPLICATIONS

This application claims priority to EP 16157465.2, filed Feb. 25, 2016, which is hereby incorporated by reference.

### BACKGROUND

The present disclosure relates to a sample container carrier for transporting sample containers, for example test tubes and/or vials, in a laboratory automation system. The invention further relates to a method for manufacturing a sample container carrier. In addition, the invention relates to a laboratory sample distribution system having a number of sample container carriers, and a laboratory automation system comprising a laboratory sample distribution system.

A laboratory automation system typically comprises a number of pre-analytical, analytical and/or post-analytical stations, in which samples, for example blood, saliva, swab and other specimens taken from the human body, are processed. It is generally known to provide various containers, such as test tubes or vials, containing the samples. The test tubes are also referred to as sample tubes. In the context of the application, containers such as test tubes or vials for containing a sample are referred to as sample containers.

Several sample containers can be placed in racks for a handling. In an alternative distribution system, sample containers are place in an upright or vertical position in sample container carriers or pucks having a retaining area for retaining sample containers.

Generally, in laboratory automation systems different kinds of sample containers are handled, in particular test tubes and/or vials with different diameters. It is further known to control the transport of the sample containers and/or a treatment of the sample contained in the sample container by a bar code provided on an outside surface of the sample container. For this purpose, the bar code should be readable during the transport and/or at all handling stations without having to remove the sample container from the carrier.

Therefore, there is a need for a sample container carrier for transporting sample containers and a method for manufacturing the sample container carrier allowing for a cost-efficient manufacturing.

### SUMMARY

According to the present disclosure, a sample container carrier for transporting sample containers in a laboratory automation system is presented. The sample container carrier can comprise a body having a hollow center with a central axis (A). The hollow center can be adapted for receiving a lower end of a sample container. The sample container carrier can also comprise at least three upper retaining elements. The three upper retaining elements can be resiliently deformable and/or displaceable. The upper retaining elements can be distributed about the central axis (A) and adapted to clamp a sample container inserted in the hollow center of the body in an area above the hollow center. The upper retaining elements can be made of plastic.

Accordingly, it is a feature of the embodiments of the present disclosure to provide for a sample container carrier for transporting sample containers and a method for manufacturing said sample container carrier allowing for a cost-efficient manufacturing. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a side view of a sample container carrier for transporting sample containers retaining a sample container according to an embodiment of the present disclosure.

FIG. 2 illustrates a side view of the sample container carrier of FIG. 1 according to an embodiment of the present disclosure.

FIG. 3 illustrates a top view of the sample container carrier of FIG. 2 according to an embodiment of the present disclosure.

FIG. 4 illustrates a sectional view along line IV-IV of the sample container carrier of FIG. 3 according to an embodiment of the present disclosure.

FIG. 5 illustrates a perspective view of a second embodiment of a sample container carrier for transporting sample containers according to an embodiment of the present disclosure.

FIG. 6 illustrates a side view of the sample container carrier of FIG. 5 according to an embodiment of the present disclosure.

FIG. 7 illustrates a top view of the sample container carrier of FIG. 5 according to an embodiment of the present disclosure.

FIG. 8 illustrates a sectional view along line VIII-VIII of the sample container carrier of FIG. 7 according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A sample container carrier for transporting sample containers in a laboratory automation system is provided. The sample container carrier can comprise a body having a hollow center with a central axis. The hollow center can be adapted for receiving a lower end of a sample container. The sample container carrier can also comprise at least three resiliently deformable and/or displaceable upper retaining elements. The upper retaining elements can be distributed about the central axis and adapted to clamp a sample container inserted in the hollow center of the body in an area above the hollow center. The upper retaining elements can be made of plastic.

A sample container carrier having retaining elements with elastic properties can be manufactured cost-efficiently. In particular, the upper retaining elements can be manufactured as integral parts with other elements by injection molding, wherein the number of assembly steps can be reduced.

In order to provide sample container carriers that are not only cost-efficient in manufacturing, but also enjoy a long life and are apt for retaining a wide range of sample containers of different sizes, in one embodiment, the upper retaining elements can be made of molding compounds on the basis of a polyamide chosen from the group comprising PA6, PA66, PA610, polyamide NDT/INDT and copolymers thereof. Suitable materials are commercially available under the trade names BASF Ultramid® S3K Balance, BASF Ultramid® NBX-0025 NF2001, BASF Ultramid® A3K, cond. Evonik Trogamid® CX9710 nc (nf). However, the invention is not limited to these materials. Other materials are conceivable that have good elastic properties and dimensional stability as well as a low tendency to creep.

In one embodiment, the upper retaining elements and the body can be formed as an integral element of one plastic or as an integral element by multiple-component injection molding. When manufacturing the upper retaining elements and the body of one plastic, proper construction techniques can be applied and the material can be chosen properly to ensure for sufficient stability of the body and sufficient elasticity of the retaining elements. When manufacturing the elements by multiple-component injection molding, the material may be chosen for each element individually.

The design of the elements can be adapted by the person skilled in the art in order to allow for a cost-efficient manufacturing by injection molding. To this end, in one embodiment, the body can comprise a sleeve having cutouts for injection molding inserts and/or injection molding dies used in manufacturing of the sample container carrier.

In one embodiment, the upper retaining elements can comprise a hooked portion having a vertex directed towards the central axis and a distal end pointing at least essentially upwards. This design can be advantageous both for ensuring reliable clamping and manufacturing by injection molding.

In accordance with one embodiment, the sample container carrier can further comprise a plurality of lower retaining elements made of plastic and arranged at least partly in the hollow center. The lower retaining elements can enhance secure positioning of the sample container in the hollow center.

In view of manufacturing constraints, in some embodiments, the lower retaining elements can be arranged in the regions radially inwards of the cutouts. This can, in particular, be advantageous in the case where the upper retaining elements and the lower retaining elements are formed as an integral element of one plastic or as an integral element by multiple-component injection molding.

In one embodiment, the upper retaining elements and the lower retaining elements can be arranged in an alternating sequence about the central axis. The number of upper and lower retaining elements can differ in one embodiment, wherein, for example, two lower retaining elements can be arranged between two upper retaining elements. In some embodiments, the number of upper and lower retaining elements can be the same and the elements can be equally spaced about the central axis.

Alternatively, or in addition, in one embodiment, the body can further comprise a number of ribs projecting from an inner shell surface of the hollow center and serving as radial contact surfaces for the sample container, wherein, in particular, the upper retaining elements and the ribs can be arranged such that each upper retaining element and each rib can be aligned in a direction substantially parallel to the central axis.

In one embodiment, the ribs can have a tapered contact surface for guiding a lower end of a sample container upon the insertion. In some embodiments, the ribs can be at least partly moveable in radial direction with respect to the inner shell surface of the hollow center.

In alternative to a number of lower retaining elements, in other embodiments, the sample container carrier can further comprise a cup shaped lower retaining element made of plastic, which can be arranged at least partly in the hollow center. The cup shaped lower retaining element in some embodiments can be made from an easily stretchable material for allowing the insertion and clamping of a large variety of sample containers of different sizes. In alternative, the cup shaped lower retaining element can be provided with slits dividing the cup shaped lower retaining element into a plurality of sections which can be independently moveable radially outwards.

The sample container carrier, in one embodiment, can further comprise a sliding disc. The sliding disc can be adapted for moving the sample container carrier over a transport plane. At least a bottom surface of the sliding disc can be made of, or coated with, a suitable material. The body, in one embodiment, can be mounted to the sliding disc, for example, by a snap-fit connection. In other embodiments, the sliding disc can be formed at least partly as an integral element with the body.

A method of manufacturing a sample container carrier is provided. At least the upper retaining elements can be formed of plastic by injection molding. A sample container carrier can be manufactured, wherein the number of parts to be assembled can be minimized by forming the upper retaining elements as an integral component together with at least one other element of the sample container carrier chosen from the group comprising the body, lower retaining elements, ribs and the sliding disc.

A laboratory sample distribution system having a number of sample container carriers is provided. The distribution system, for example, can comprise a transport plane with a number of magnetic actuators for generating a magnetic field such that a driving force is applied to each of the sample container carriers for transporting the sample container carriers. Such a system is described for example in WO 2013/064656 A1 and incorporated herein by reference. The distribution system, in alternative or in addition, in one embodiment, can comprise additional conveyor devices for moving a sample container carrier along a defined path.

A laboratory automation system with a number of pre-analytical, analytical and/or post-analytical stations and with a distribution system having a number of sample container carriers is provided.

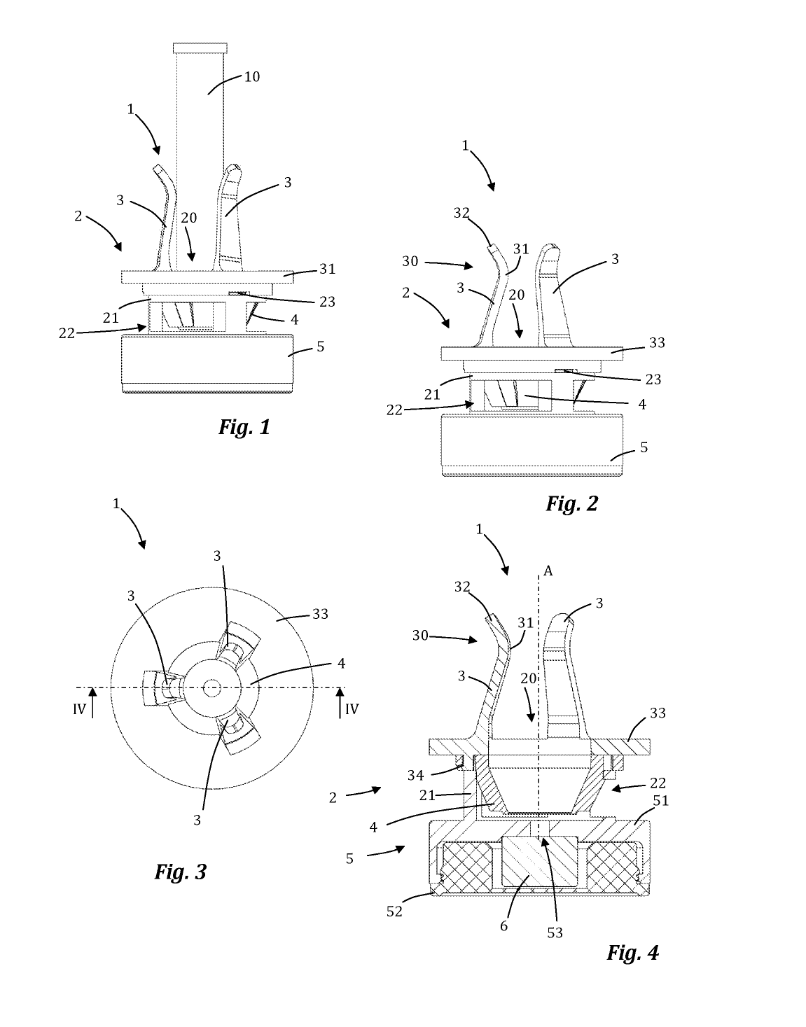

FIGS. 1 to 4 show a first embodiment of a sample container carrier 1 for transporting sample containers 10 (see FIG. 1). The sample container carrier 1 shown in FIGS. 1 to 4 can comprise a body 2 having a hollow center 20 with a central axis A, three resiliently deformable and displaceable upper retaining elements 3, a cup shaped lower retaining element 4 arranged in the hollow center 20, and a sliding disc 5.

All elements can be made of plastic such as, for example, made by injection molding of molding compounds on the basis of a polyamide chosen from the group comprising PA6, PA66, PA610, polyamide NDT/INDT and copolymers thereof. The elements 2, 3, 4, 5 of the sample container carrier 1 or parts thereof can be formed as integral components with other elements 2, 3, 4, 5 of the sample container carrier 1 or parts thereof.

The body 2 can comprise a sleeve 21 surrounding the hollow center. The sleeve 21 can have cutouts 22 for injection molding inserts or injection molding dies (not shown) used in manufacturing of the sample container carrier 1.

The sliding disc 5 can comprise two coupled elements 51, 52 accommodating in-between them can be a magnetically active element 6 adapted to interact with a magnetic field such that a driving force is applied to the sample container carrier 1. In the embodiment shown, due to production-related issues, an upper element 51 of the sliding disc 5 can be provided with a hole 53. In other embodiments, this hole can be avoided.

In the embodiment shown, the upper element 51 of the sliding disc 5 can be formed integrally with the body 2. In other embodiments, the elements can be formed separately and assembled for example by a snap-fit connection and/or by gluing or welding.

The upper retaining elements 3 can each comprise a hooked portion 30 having a vertex 31 directed toward the central axis A and a distal end 32 pointing at least essentially upwards. In the embodiment shown, the three upper retaining elements 3 can be formed as a common component and linked by a ring-shaped disc 33. The size of the ring-shaped disc 33 can be chosen such that the disc 33 can project in radial direction from the sleeve 21 for forming a rim such that a guiding groove for interacting with conveyor elements such as rails, hooks or the like of a laboratory sample distribution system (not shown) can be provided.

In the embodiment shown, the component with the upper retaining elements 3 and the body 2 can be manufactured as separate elements and coupled by a snap-fit connection. For this purpose, the component with the upper retaining elements 3 can comprise three snap-in hooks 34 interacting with slots 23 provided on the sleeve 21. The cup shaped lower retaining element 4 can be inserted between the component with the upper retaining elements 3 and the based body 2. In other embodiments, all three components can be formed integrally by injection molding. In one embodiment, the carrier can be manufactured by multiple-component injection molding. In this case, the cup shaped lower retaining element 4 can be made of a material having a higher elasticity than the other elements.

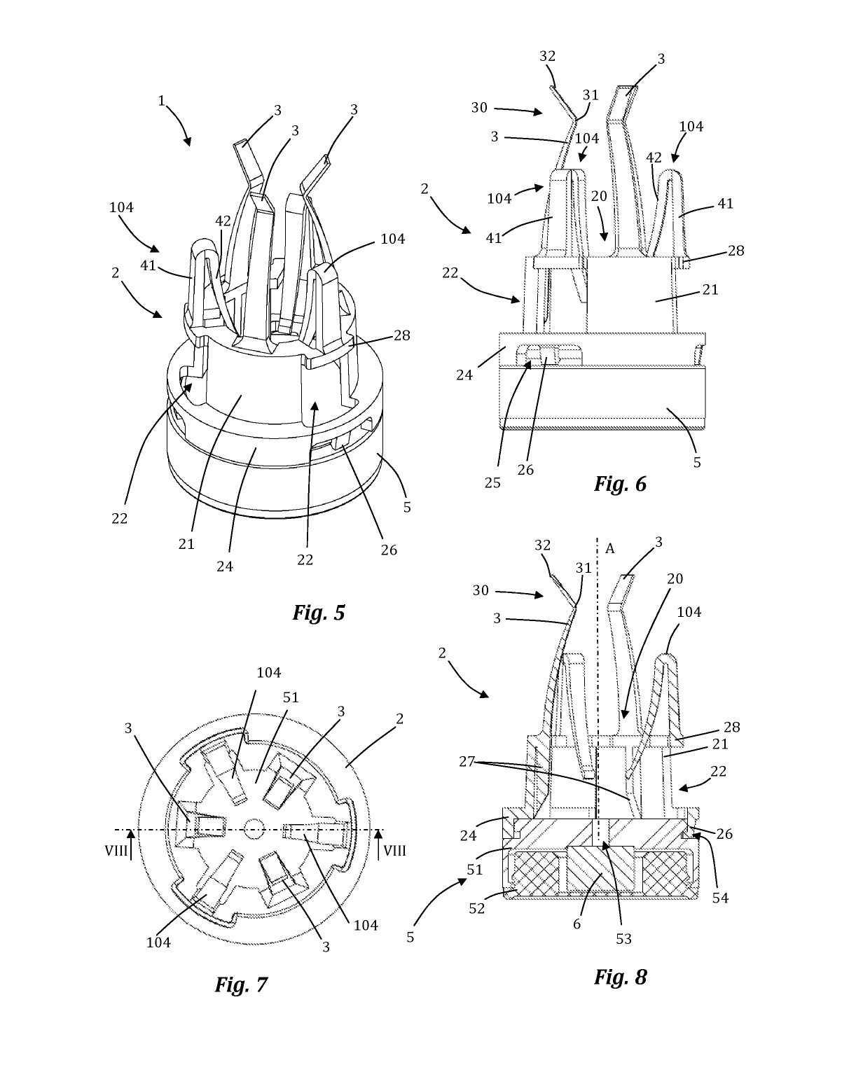

FIGS. 5 to 8 show a second embodiment of a sample container carrier 1 for transporting sample containers 10 (see FIG. 1), comprising a body 2 having a hollow center 20 with a central axis A, three resiliently deformable and displaceable upper retaining elements 3, three resiliently deformable and displaceable lower retaining elements 104 arranged at least partly in the hollow center 20, and a sliding disc 5.

The hollow center 20 can be adapted for accommodating a lower end of a sample container (not shown in FIGS. 5 to 8). The sample container can be clamped by the first and the second retaining elements 3, 104 at two different heights.

In the embodiment shown in FIGS. 5 to 8, also all elements can be made of plastic such as, for example, made by injection molding of molding compounds on the basis of a polyamide chosen from the group comprising PA6, PA66, PA610, polyamide NDT/INDT and copolymers thereof. The upper retaining elements 3, the lower retaining elements 104 and the body 2 can be formed as an integral component. In one embodiment, they can be formed as an integral component by injection molding of one molding compound. This integral component can be mounted to the sliding disc 5.

The sliding disc 5 can comprise an upper element 51 and a lower element 52 accommodating in-between them can be a magnetically active element 6 adapted to interact with a magnetic field such that a driving force can be applied to the sample container carrier 1. Due to production-related issues, in the embodiment shown, the upper element 51 of the sliding disc 5 can be provided with a hole 53. In other embodiments, no such hole may be provided.

The body 2 can comprise a first sleeve 21 surrounding the hollow center 20. The first sleeve 21 can be provided with cutouts 22 for injection molding inserts or injection molding dies (not shown). The body 2 can further comprise a second sleeve 24, which can serve as a mounting sleeve for mounting the basic body 2 to the sliding disc 5. The mounting sleeve 24 can be provided with cutouts 25 for forming snap-in hooks 26. The snap-in hooks 26 can interact with a groove 54 provided on the upper element 51 of the sliding disc 5. The outer diameter of the mounting sleeve 24 can correspond to the outer diameter of the sliding disc 5.

The body 2 can further comprise a number of ribs 27 radially projecting from an inner shell surface of the sleeve 21 surrounding the hollow center 20 and serving as radial contact surfaces for the sample container 10 (see FIG. 1). The upper retaining elements 3 and the ribs 27 can be arranged such that in each case one upper retaining element 3 and one rib 27 can be aligned in a direction substantially parallel to the central axis A.

A front edge of the ribs 27 can extend at least essentially in parallel to the central axis A. In order to ease a guidance of a sample container upon insertion into the hollow 20, the ribs 27 can only be partly connected to the sleeve 21. More particular, in the embodiment shown, the ribs 27 can be connected only at their upper ends to the sleeve 21. Hence, the ribs 27 can be within small limits moveable in radial direction with respect to the inner shell surface of the sleeve 21 surrounding the hollow 20.

In the embodiment shown, in the lower retaining elements 104 and the ribs 27, and the lower retaining elements 104 and the upper retaining elements 3 can be arranged in an alternating sequence about the central axis A.

The upper retaining elements 3 can project upwards from an upper edge of the sleeve 21 and can comprise a hooked portion 30 having a vertex 31 directed towards the central axis A and a distal end 32 pointing at least essentially upwards.

In the embodiment shown, the lower retaining elements 104 can be V-shaped, having a first leg 41 and a second leg 42 of different length. The first legs 41 can project upwards from the upper edge of the sleeve 21. They can be shorter than the upper retaining elements 3. The second legs 42 can project downwards and can extend into the hollow center 20. A sample container 10 inserted into the hollow center 20 can contact at least distal ends of the second legs 42.

In contrast to the first embodiment, in the embodiment of FIGS. 5 to 8, no circumferential rim may be provided at the upper edge of the sleeve 21, in order to allow for a design of the sample container carrier 1 that can minimize undercuts. Instead of such a rim, projections 28 extending radially outwards can be provided at an upper edge of the sleeve 21 surrounding the hollow center 20. Projections 28 together with the mounting sleeve 22 can form a guide groove allowing a movement of the sample container carrier 1 with or without a sample container 10 along a rail or a similar element of a laboratory sample distribution system (not shown).

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A sample container carrier for transporting sample containers in a laboratory automation system, the sample container carrier comprising:
a body having a hollow center with a central axis (A), wherein the hollow center is adapted for receiving a lower end of a sample container; and
at least three upper retaining elements, wherein the three upper retaining elements are resiliently deformable and/or displaceable, wherein the upper retaining elements are distributed about the central axis (A) and adapted to clamp a sample container inserted in the hollow center of the body in an area above the hollow center, and wherein the upper retaining elements are made of plastic.

2. The sample container carrier according to claim 1, wherein the upper retaining elements are made of molding compounds on the basis of a polyamide chosen from the group comprising PA6, PA66, PA610, polyamide NDT/INDT and copolymers thereof.

3. The sample container carrier according to claim 1, wherein the upper retaining elements and the body are formed as an integral element of one plastic or as an integral element by multiple-component injection molding.

4. The sample container carrier according to claim 1, wherein the body comprises a sleeve having cutouts for injection molding inserts and/or injection molding dies used in manufacturing of the sample container carrier.

5. The sample container carrier according to claim 1, wherein the upper retaining elements comprise a hooked portion having a vertex directed towards the central axis (A) and a distal end pointing at least essentially upwards.

6. The sample container carrier according to claim 1, further comprises,
a plurality of lower retaining elements made of plastic and arranged at least partly in the hollow center.

7. The sample container carrier according to claim 6, wherein the plurality of lower retaining elements is arranged in regions radially inwards of the cutouts.

8. The sample container carrier according to claim 6, wherein the upper retaining elements and the lower retaining elements are formed as an integral element of one plastic or as an integral element by multiple-component injection molding.

9. The sample container carrier of claim 6, wherein the upper retaining elements and the lower retaining elements are arranged in an alternating sequence about the central axis (A).

10. The sample container carrier according to claim 1, wherein the body further comprises a number of ribs projecting from an inner shell surface of the hollow center and serving as radial contact surfaces for the sample container.

11. The sample container carrier according to claim 10, wherein the upper retaining elements and the ribs are arranged such that in each case one upper retaining element and one rib are aligned in a direction parallel to the central axis (A).

12. The sample container carrier of claim 10, wherein the ribs are at least partly moveable in radial direction with respect to the inner shell surface of the hollow center.

13. The sample container carrier according to claim 1, further comprises,
a cup shaped lower retaining element made of plastic and arranged at least partly in the hollow center.

14. The sample container carrier according to claim 1, further comprises, a sliding disc.

15. The sample container carrier according to claim 14, wherein the body is mounted to the sliding disc.

16. The sample container carrier according to claim 14, wherein the sliding disc is formed at least partly as an integral element with the body.

17. A method of manufacturing a sample container carrier according to claim 1, wherein at least the upper retaining elements are formed by injection molding.

18. A laboratory sample distribution system having a number of sample container carriers according to claim 1.

19. A laboratory automation system with a number of pre-analytical, analytical and/or post-analytical stations and with the laboratory sample distribution system according to claim 18.
